(19) United States
(12) Patent Application Publication
(10) Pub. No.: US 2017/0251644 A1
(43) Pub. Date: Sep. 7, 2017

(54) Lighting System Positioned under Aquarium and Aquarium Having the Same

(71) Applicant: Northern Sky Ventures Limited, Hong Kong (HK)

(72) Inventor: Michael Brown, Ottawa (CA)

(21) Appl. No.: 15/446,017

(22) Filed: Mar. 1, 2017

(30) Foreign Application Priority Data
Mar. 1, 2016 (CN) 201620157178.1

(51) Int. Cl. A01K 63/06; H05B 33/08; F21S 9/02; H05B 37/02

(52) U.S. Cl. CPC A01K 63/06; H05B 37/0272; H05B 33/0857; F21S 9/02; F21Y 2115/10

(57) ABSTRACT

The present invention discloses a lighting system positioned under an aquarium, which comprises a frame having a same shape and size, or a different shape and lesser size, as a bottom of the aquarium; and a plurality of LED lights positioned inwardly around the perimeter of the frame. The present invention further discloses an aquarium comprising the aquarium lighting system of the invention which is positioned under the aquarium. In the aquarium lighting system and the aquarium provided by the invention, the LED lights illuminate toward the center of the frame and illuminate the bottom of the aquarium, thus providing a better view of the animals in the aquarium and providing unique lighting effects on aquaria decor.

### CROSS REFERENCE TO RELATED APPLICATIONS

The present application claims the benefit of Chinese Utility Model Application No. 201620157178.1 filed on Mar. 1, 2016. All the above are hereby incorporated by reference.

### FIELD OF THE INVENTION

The present invention relates to an aquarium lighting system and an aquarium, and more particularly to a lighting system positioned under an aquarium and an aquarium having the same.

### BACKGROUND OF THE INVENTION

Lighting systems for aquariums are traditionally arranged on the top of the aquarium to illuminate the aquarium, and some other lighting systems for aquariums are positioned inside the aquarium with electric wires arranged in the water.

In addition, some lighting systems are used in the aquariums with no water used for reptiles such as snakes and lizards, as well as in the aquariums with shallow water used for frogs, turtles, salamanders, etc.

When the lighting system is arranged on the top of the aquarium containing no water or shallow water, the viewing effect will be discounted; and when the lighting system is arranged inside the aquarium, the electric wires or the like detract from the aesthetic beauty of the aquarium and adversely affect the viewing of the animals.

### SUMMARY OF THE INVENTION

The present invention discloses alighting system that is positioned under an aquarium to provide a better view of the animals, as well as to provide unique lighting effects on typical aquaria decor, so as to overcome the disadvantages of the prior art. The aquarium lighting system of the present invention can be implemented as the aquariums are usually made of transparent glass.

The present invention discloses a lighting system positioned under an aquarium, comprising a frame having a same shape and size, or a different shape and lesser size, as the bottom of the aquarium; and a plurality of LED lights positioned inwardly around the perimeter of the frame.

Preferably, the frame and the bottom of the aquarium are formed as a one-piece structure.

Preferably, the frame is formed as a separate structure to be mounted to the bottom of the aquarium.

Preferably, he lighting system further comprises a power supply circuit for connecting an external power source.

Preferably, the lighting system further comprises a battery pack that provides power to the LED lights.

Preferably, the plurality of LED lights are LED lights emitting light of various colors, and the lighting system further comprises a programmable controller connected to the plurality of LED lights. The programmable controller controls the plurality of LED light to emit light in the course of time to display a dynamic lighting effect and a variety of colors.

Further, the programmable controller comprises a wireless remote control unit for receiving instructions from an external remote control device to control the controller.

Further, the wireless remote control unit is an infrared remote control unit or a radio-frequency unit.

The present invention further discloses an aquarium comprising any of those lighting systems positioned under an aquarium as described above.

In the aquarium lighting system and the aquarium provided by the invention, the LED lights illuminate toward the center of the frame to illuminate the bottom of the aquarium, and as such, the animals in the aquarium can be viewed in a beneficial way. In addition, the aquarium lighting system and the aquarium provided by the invention provides unique lighting effects on typical aquaria decor.

### BRIEF DESCRIPTION OF THE DRAWINGS

FIG. 1 is a schematic diagram of an aquarium lighting system of an embodiment of the present invention;

FIG. 2 is a schematic diagram of an aquarium having a lighting system positioned under the aquarium, the lighting system having a same shape and size as the bottom of the aquarium.

FIG. 3 is a schematic diagram of an aquarium having a lighting system positioned under the aquarium, the lighting system having a different shape and lesser size as the bottom of the aquarium.

FIG. 4 is a schematic diagram of an aquarium being illuminated by LED lights positioned under the aquarium.

### DETAILED DESCRIPTION OF SHOWN EMBODIMENTS

Hereinafter, the embodiments of the invention will be described clearly and completely with reference to the accompanying drawings. Obviously, those exemplary embodiments are only a part of the embodiments of the invention. According to the embodiments, all of the other embodiments obtained by those skilled in the art in the light of the teachings of the invention are included within the scope of the invention.

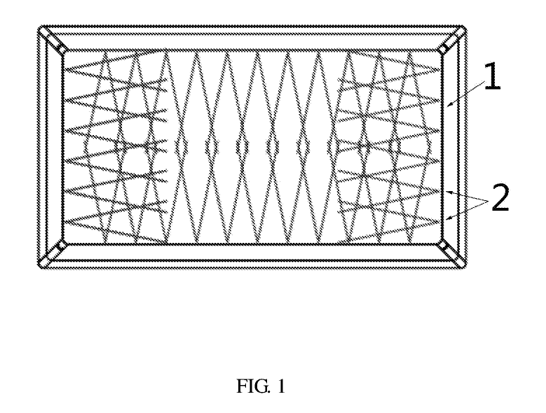

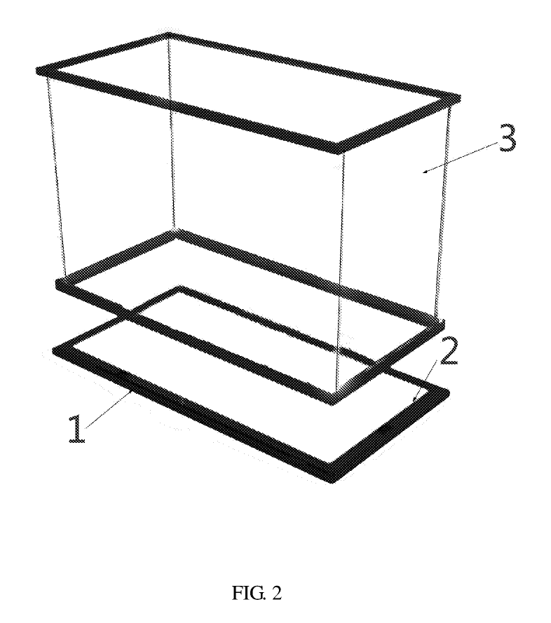

FIG. 1 is a schematic diagram of one embodiment of an aquarium lighting system of the present invention. Referring to FIG. 1 and FIG. 2, a lighting system positioned under an aquarium 3 comprises a frame 1 having a same shape and size as a bottom of the aquarium 3; and a plurality of LED lights 2 positioned inwardly around the perimeter of the frame 1.

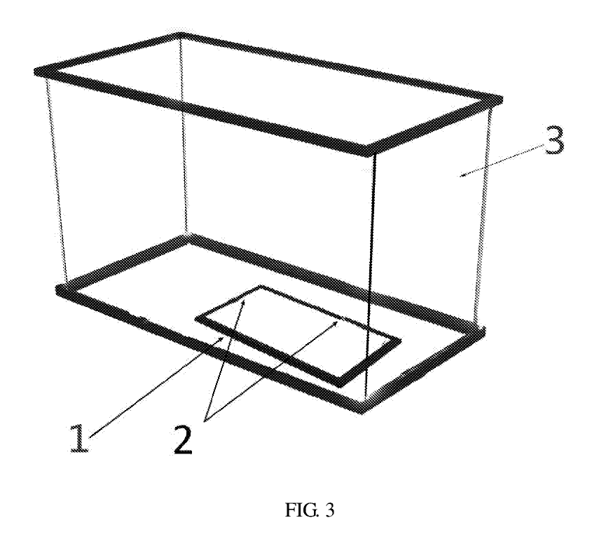

FIG. 3 is a schematic diagram of another embodiment of an aquarium lighting system of the present invention. Referring to FIG. 3, a lighting system positioned under an aquarium 3 comprises a frame 1 having a different shape and lesser size as a bottom of the aquarium 3; and a plurality of LED lights 2 positioned inwardly around the perimeter of the frame 1. Such an embodiment allows for localized lighting of an aquarium for dramatic effect. One or more such lighting systems may be used beneath a large aquarium to produce a desired effect.

In some embodiments, the frame 1 and the bottom of the aquarium 3 are formed as a one-piece structure. In the manufacturing of the aquarium, the frame 1 is embedded under the bottom of the aquarium that is made of glass, and the plurality of LED lights 2 are positioned inwardly around the perimeter of the frame 1. However, in other embodiments, the frame 1 may be formed as a separate structure to be mounted to the bottom of the aquarium 3. The size of the bottom of the aquarium 3, in particular the size of the perimeter of the bottom, may be measured before manufacturing the frame 1. After the frame 1, the size of which corresponding to that of the bottom, has been manufactured, the plurality of LED lights 2 are mounted inwardly around the perimeter of the frame 1. The plurality of LED lights 2 which are positioned inwardly around the perimeter of the frame 1 illuminate the bottom of the aquarium 3, thus providing a pleasing view of the animals in the aquarium 3.

The aquarium lighting system further comprises a power supply circuit for connecting to an external power source. The power supply circuit may be an integrated device comprising a transformer and a control circuit, which is connected to the mains supply to provide power to the LED lights 2 and control the LED lights to turn on and off.

In another embodiment of the invention, the aquarium lighting system further comprises a battery pack that provides power to the LED lights 2. In the battery pack, a plurality of batteries are in a series or parallel connection or a combination thereof, so as to supply power to the plurality of LED lights 2.

The plurality of LED lights 2 are LED lights emitting light of various colors, and the aquarium lighting system further comprises a programmable controller connected to the plurality of LED lights 2. The controller controls the plurality of LED light 2 that are grouped to display a dynamic lighting effect in the course of time and a variety of colors. Such dynamic lighting effect may be achieved by flickering lights of single color, or may be achieved by alternating lights of different colors, or may be achieved by alternating lights of LED lights 2 on the different sides of the frame 1, or may be achieved by alternating lights of LED lights 2 on the same side of the frame 1.

The programmable controller further comprises a wireless remote control unit for receiving instructions from an external remote control device to control the programmable controller. The external remote control device may be an infrared remote control unit or other control device such as a mobile application, which controls the programmable controller by wireless via wi-fi, infrared or Bluetooth to turn on and off the LED lights 2 or to program the mode of emitting light.

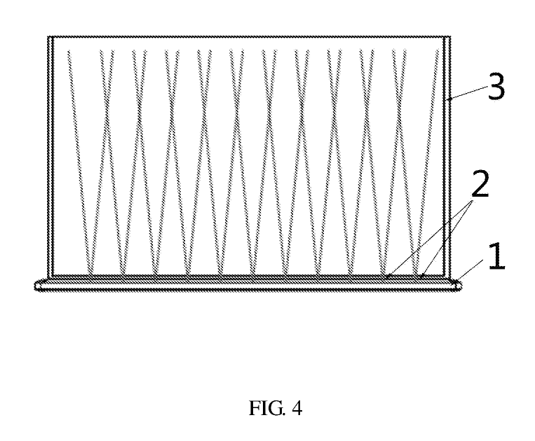

Referring to FIGS. 2 and 4, an aquarium having a lighting system positioned under the aquarium is also disclosed in the present invention. The aquarium comprises any of those lighting systems as described above. The frame 1 and the bottom of the aquarium 3 may be formed as a one-piece structure. In the manufacturing of the aquarium, the frame 1 is embedded under the bottom of the aquarium that is made of glass, and the plurality of LED lights 2 are positioned inwardly around the perimeter of the frame 1. However, in other embodiments, the frame 1 may be formed as a separate structure to be mounted to the bottom of the aquarium 3. The size of the bottom of the aquarium 3, in particular the size of the perimeter of the bottom, may be measured before manufacturing the frame 1. After the frame 1, the size of which corresponding to that of the bottom, has been manufactured, the plurality of LED lights 2 are mounted inwardly around the perimeter of the frame 1.

The present invention has been described with reference to preferred embodiments thereof. However, those skilled in the art will understand that variations and modifications can be made without departing from the principles and spirit of the invention, and these variations and modifications also fall within the scope of the invention.

What is claimed is:

1. A lighting system positioned under an aquarium, characterized in that the lighting system comprises:
a frame having a same shape and size or a different shape and lesser size as a bottom of the aquarium; and
a plurality of LED lights positioned inwardly around the perimeter of the frame.

2. The lighting system of claim 1, characterized in that the frame and the bottom of aquarium are formed as a one-piece structure.

3. The lighting system of claim 1, characterized in that the frame is formed as a separate structure to be mounted to the bottom of the aquarium.

4. The lighting system of claim 1, characterized in that the lighting system further comprises a power supply circuit for connecting an external power source.

5. The lighting system of claim 1, characterized in that the lighting system further comprises a battery pack that provides power to the LED lights.

6. The lighting system of claim 1, characterized in that the plurality of LED lights are LED lights emitting various colors, and the lighting system further comprises a programmable controller connected to the plurality of LED lights.

7. The lighting system of claim 6, characterized in that the programmable controller further comprises a wireless remote control unit for receiving instructions from an external remote control device to control the programmable controller.

8. The lighting system of claim 7, characterized in that the wireless remote control unit is an infrared remote control unit, or a radio frequency unit, or bluetooth.

9. An aquarium, characterized in that the aquarium comprises the lighting system positioned under an aquarium of claim 1.

10. An aquarium, characterized in that the aquarium comprises the lighting system positioned under an aquarium of claim 2.

11. An aquarium, characterized in that the aquarium comprises the lighting system positioned under an aquarium of claim 3.

12. An aquarium, characterized in that the aquarium comprises the lighting system positioned under an aquarium of claim 4.

13. An aquarium, characterized in that the aquarium comprises the lighting system positioned under an aquarium of claim 5.

14. An aquarium, characterized in that the aquarium comprises the lighting system positioned under an aquarium of claim 6.

15. An aquarium, characterized in that the aquarium comprises the lighting system positioned under an aquarium of claim 7.

16. An aquarium, characterized in that the aquarium comprises the lighting system positioned under an aquarium of claim 8.
